(19) United States
(12) Patent Application Publication
(10) Pub. No.: US 2023/0081989 A1
(43) Pub. Date: Mar. 16, 2023

(54) OXYGEN CONTROL SYSTEM WITH IMPROVED PRESSURE REGULATOR

(71) Applicant: AVOX Systems Inc., Lancaster, NY (US)

(72) Inventor: Christopher Miller, Lancaster, NY (US)

(21) Appl. No.: 17/473,619

(22) Filed: Sep. 13, 2021

(51) Int. Cl. A62B 7/02; G05D 16/06; G05D 7/06; A62B 7/12; A62B 9/02; A62B 9/00; A62B 7/10; A62B 23/02

(52) U.S. Cl. CPC A62B 7/02; G05D 16/0619; G05D 7/0635; A62B 7/12; A62B 9/02; A62B 9/006; A62B 7/10; A62B 23/02

(57) ABSTRACT

Described are oxygen control systems that utilize compressed air or oxygen. The oxygen control systems may include a control device having a first inlet that enables the flow of a supply gas from a high pressure gas source at an input pressure into the control device. The control device also includes a second inlet that enables a flow of atmospheric air into the control device and an outlet in fluid communication with the first inlet and the second inlet. The control device also includes a pressure regulator that is operable in a first mode and a second mode. In the first mode, the pressure regulator reduces input pressure of the gas to a first outlet pressure at the outlet, and, in the second mode, the pressure regulator reduces the input pressure of the gas to a second outlet pressure at the outlet that is greater than the first outlet pressure.

### FIELD OF THE INVENTION

The field of the invention relates to oxygen control systems for oxygen masks, respirators, or other oxygen systems, and, more particularly, to oxygen control systems that utilize compressed or high pressure air or oxygen for breathing.

### BACKGROUND

Oxygen control systems are commonly used to supply air or oxygen to a user for breathing in various situations or applications. As some non-limiting examples, oxygen control systems may be used to provide oxygen or air in applications using chemical, biological, radiological, or nuclear (CBRN) systems, aircraft oxygen masks, high altitude low open (HALO) systems, high altitude high open (HAHO) systems, self-contained breathing apparatus (SCBA) systems, and/or other applications or systems as desired. Some oxygen control systems utilize compressed or high pressure air or oxygen as an oxygen source, however such systems typically cannot be used in applications that require a low air pressure, and a separate low pressure oxygen source must be used. As an example, a CBRN respirator may require the air or oxygen be at a low pressure to be operable, and traditionally cannot be utilized with a high pressure gas source.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

According to certain embodiments of the present invention, an oxygen control system includes a supply line configured to provide a flow of a supply gas at an input pressure, a control device, and an outlet line. The control device includes a first inlet in fluid communication with the supply line, and the first inlet enables the flow of the supply gas at an input pressure into the control device. The control device also includes a second inlet that enables a flow of atmospheric air into the control device and an outlet in fluid communication with the first inlet and the second inlet. In certain embodiments, the control device includes a pressure regulator that is operable in a first mode and a second mode. In some embodiments, in the first mode, the pressure regulator reduces input pressure of the supply gas to a first outlet pressure at the outlet, and, in the second mode, the pressure regulator reduces the input pressure of the supply gas to a second outlet pressure at the outlet that is greater than the first outlet pressure. The outlet line is connected to the outlet of the control device and is configured to supply the supply gas at the first outlet pressure or the second outlet pressure. The first outlet pressure and the second outlet pressure may be less than the input pressure.

In some embodiments, the control device also includes an inlet controller configured to control the flow of atmospheric air through the second inlet and into the control device. The inlet controller may be movable between an open position and a closed position. In certain embodiments, the control device is operable in a first base mode, a second base mode, and an emergency mode, where, in the first base mode, the pressure regulator is in the first mode and the inlet controller is in the open position, in the second base mode, the pressure regulator is in the first mode and the inlet controller is in the closed position, and, in the emergency mode, the pressure regulator is in the second mode and the second inlet is in the closed position.

In various embodiments, the supply line includes a supply line connector that is configured to interface with the high pressure gas source. The supply line may include a visual flow indicator. In certain embodiments, the supply gas from the supply line is 100% oxygen.

In certain embodiments, the system may also include a filter adaptor connected to the outlet line opposite from the control device. The filter adaptor may be configured to cover a filter body of a CBRN filter. In some cases, the filter adaptor includes an adaptor inlet and an adaptor outlet. The adaptor inlet may be connected to the outlet line, and the adaptor outlet includes at least two tangs configured to selectively retain the filter on the filter adaptor. In some embodiments, the filter adaptor is connectable to an oxygen mask.

According to certain embodiments of the present invention, an oxygen control system for an oxygen mask includes a control device, and the control device includes a first inlet, a second inlet, an inlet controller, an outlet, and a pressure regulator. The first inlet enables a flow of a supply gas from a high pressure gas source, and the second inlet enables a flow of atmospheric air into the control device. The inlet controller is configured to control the flow of atmospheric air through the second inlet and into the control device, and the inlet controller is movable between an open position and a closed position. The outlet is in fluid communication with the first inlet and the second inlet. The pressure regulator is operable in a first mode and a second mode. In the first mode, the pressure regulator reduces input pressure of the supply gas to a first outlet pressure at the outlet, and, in the second mode, the pressure regulator reduces the input pressure of the supply gas to a second outlet pressure at the outlet that is greater than the first outlet pressure. In certain embodiments, the control device is operable in a first base mode, a second base mode, and an emergency mode. In the first base mode, the pressure regulator is in the first mode and the inlet controller is in the open position, in the second base mode, the pressure regulator is in the first mode and the inlet controller is in the closed position, and in the emergency mode, the pressure regulator is in the second mode and the inlet controller is in the closed position.

In some embodiments, the system includes a supply line connected to the first inlet. The supply line may provide the supply gas at an input pressure that is greater than the first outlet pressure and the second outlet pressure. In certain embodiments, the system also includes an outlet line connected to the outlet and a filter adaptor connected to the outlet line. The filter adaptor may be configured to cover a filter body of a CBRN filter.

In certain embodiments, the inlet controller includes a cover rotatably supported on the control device. The pressure regulator may include a bellows style aneroid.

According to certain embodiments of the present invention, an oxygen control system includes a control device, an outlet line, and a filter adaptor. The control device may include a first inlet that enables a flow of supply gas into the control device at an input pressure and a second inlet that enables a flow of atmospheric air into the control device. The control device may also include an inlet controller configured to control the flow of atmospheric air through the second inlet and into the control device. The inlet controller may be movable between an open position and a closed position. In some examples, the control device includes a pressure regulator that is operable in a first mode and a second mode, where, in the first mode, the pressure regulator reduces input pressure of the supply gas to a first outlet pressure at the outlet, and, in the second mode, the pressure regulator reduces the input pressure of the supply gas to a second outlet pressure at the outlet that is greater than the first outlet pressure. The outlet line may be connected to the outlet of the control device, and the filter adaptor may be connected to the outlet line. In certain embodiments, the filter adaptor is configured to cover a filter body of CBRN filter.

In various embodiments, the system also includes a supply line connected to the first inlet and connectable to the high pressure gas source. The supply line may supply the supply gas from the high pressure gas source. In certain embodiments, the input pressure in the supply line is greater than the first outlet pressure and the second outlet pressure.

In some embodiments, the control device is operable in a first base mode, a second base mode, and an emergency mode, where, in the first base mode, the pressure regulator is in the first mode and the inlet controller is in the open position, in the second base mode, the pressure regulator is in the first mode and the inlet controller is in the closed position, and in the emergency mode, the pressure regulator is in the second mode and the inlet controller is in the closed position.

In certain embodiments, the filter adaptor includes an adaptor inlet and an adaptor outlet. The adaptor inlet may be connected to the outlet line, and the adaptor outlet may include at least two tangs configured to selectively retain the filter on the filter adaptor.

Various implementations described in the present disclosure can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

FIG. 1 illustrates an oxygen mask with components of an oxygen control system according to certain embodiments of the present invention.

FIG. 2 is a diagram representation of a control device of an oxygen control system according to certain embodiments of the present invention, and the control device is in a first base mode.

FIG. 3 is another representation of the control device of FIG. 2 with the control device in the first base mode.

FIG. 4 is another representation of the control device of FIG. 2 with the control device in a second base mode.

FIG. 5 is another representation of the control device of FIG. 2 with the control device in an emergency mode.

FIG. 6 is a view of an oxygen control system according to various embodiments.

FIG. 7 is another view of the oxygen control system of FIG. 6.

FIG. 8 is a front view of an adaptor of the oxygen control system of FIG. 6.

FIG. 9 is a back view of the adaptor of FIG. 8.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. Directional references such as “up,” “down,” “top,” “bottom,” “left,” “right,” “forward,” and “aft,” among others, are intended to refer to the orientation as illustrated and described in the figure (or figures) to which the components and directions are referencing but are not intended to imply any particular configuration.

Described herein are oxygen control systems that utilize compressed or high pressure air or oxygen for breathing. The oxygen control systems may be utilized with various oxygen systems, including, but not limited to, CBRN masks or respirators, aircraft oxygen masks, HALO systems, HAHO systems, SCBA systems, and/or other applications as desired. In various aspects, the oxygen control systems described herein includes a control device that receives a supply of high pressure oxygen or air from a high pressure gas source and reduces the air pressure to low pressure ranges. In some examples, the oxygen control systems described herein may allow for air dilution by titrating a mixture of atmospheric air and oxygen from the high pressure gas source based on the pressure that the control device is exposed to, which may extend duration of the fixed capacity oxygen source. In various examples, the oxygen control systems described herein may be operable in various modes to provide a desired air dilution and/or air pressure to the user. In some examples, the oxygen control systems described herein may include connectors such that the oxygen control systems may be retrofit with existing applications or provided natively with applications. Optionally, the oxygen control systems described herein may provide an interface for a CBRN filter system such that the oxygen control system can seal directly against an inlet of the CBRN filter system. Various other benefits and improvements may be realized with the oxygen control systems described herein, and the aforementioned examples should not be considered limiting.

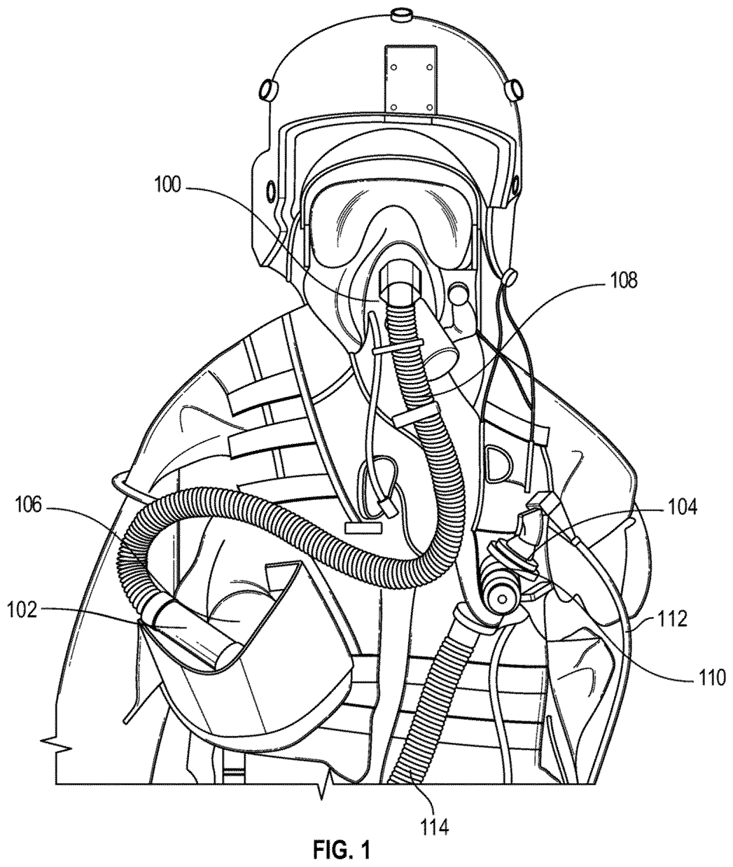

FIG. 1 illustrates an example of an oxygen mask 100 with a CBRN filter system 102 and an oxygen control system 104 according to various embodiments. The oxygen mask 100 and CBRN filter system 102 illustrated in FIG. 1 should not be considered limiting, and the oxygen control system 104 may be utilized with various other systems as desired. In FIG. 1, the CBRN filter system 102 includes a CBRN filter 106 supported at an inlet of the CBRN filter system 102, and the CBRN filter system 102 is connected to the oxygen mask 100 via a low pressure line 108 (e.g., hose, tubing, etc.). When used, the CBRN filter system 102 may filter, scrub, remove, reduce and/or otherwise treat air supplied to the oxygen mask 100 such that contaminants in the air are removed or reduced to levels that are safe for the user of the oxygen mask 100.

The oxygen control system 104 includes a control device 110, a supply line 112 (e.g., a hose, tubing, etc.), and an outlet line 114 (e.g., a hose, tubing, etc.). In FIG. 1, the outlet line 114 is shown disconnected from the CBRN filter system 102 and/or the oxygen mask 100, but in other embodiments and as discussed below, the oxygen control system 104 may optionally include an adaptor that interfaces with the CBRN filter system 102 and/or may directly attach to the oxygen mask 100. The supply line 112 is connectable to a high pressure gas source such that a supply gas that includes oxygen can be supplied to the control device 110. Optionally, the supply gas in the supply line 112 may be 100% oxygen, although in other embodiments the high pressure gas source may provide the supply gas with oxygen at other concentrations. The supply gas from the supply line 112 may be provided at an input pressure, and the control device 110 reduces the pressure from the input pressure to a desired outlet pressure and provides breathable gas at the desired outlet pressure to a user via the outlet line 114. As discussed in detail below, the control device 110 may be operable in various modes to control the outlet pressure and/or a mixture of the supply gas and atmospheric air that is supplied to the user via the outlet line 114.

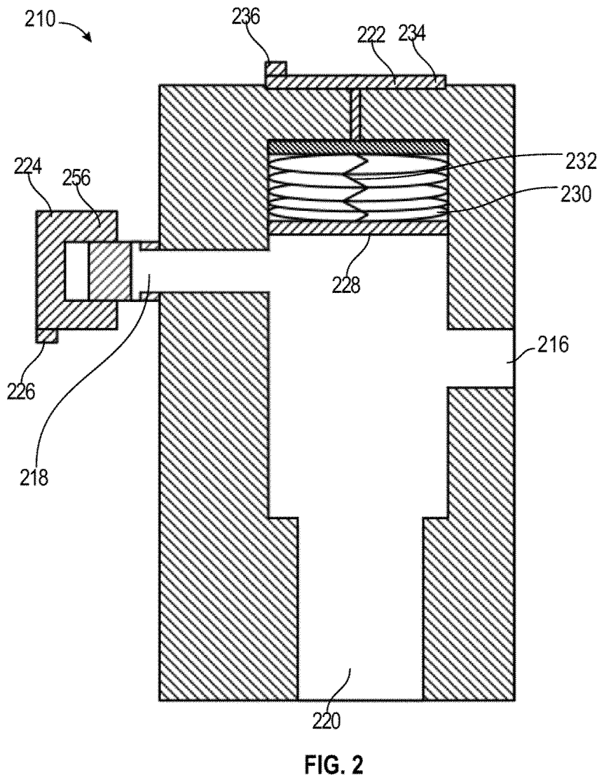

FIGS. 2-5 are schematic representations of a control device 210 for an oxygen control system such as the oxygen control system 104. In certain embodiments, the control device 210 may be substantially similar to the control device 110. As illustrated in FIGS. 2-5, the control device 210 includes a first inlet 216, a second inlet 218, an outlet 220, and a pressure regulator 222.

The first inlet 216 enables a flow of supply gas at an input pressure from the supply line 112 into the control device 210. While not illustrated in FIG. 2, the control device 210 may include various devices, mechanisms, or components that may selectively connect the supply line 112 with the control device 210 such that the supply line 112 is in fluid communication with the first inlet 216. In some embodiments, the supply gas flowing through the first inlet 216 may include 100% oxygen, although in other embodiments the supply gas may have a concentration of oxygen that is less than 100%. In some embodiments, the input pressure of the supply gas may be 50-90 PSIG, although in other embodiments the input pressure of the supply gas may be other pressures as desired.

The second inlet 218 enables a flow of atmospheric air into the control device 210. In certain embodiments, the control device 210 includes an inlet controller 224 that is movable between an open configuration and a closed configuration. Moving the inlet controller 224 between the open configuration and the closed configuration may control the flow of atmospheric air through the second inlet 218 and into the control device 210. In certain embodiments, in the open configuration, the inlet controller 224 enables the flow of atmospheric air through the second inlet 218, and in the closed configuration, the inlet controller 224 prevents the flow of atmospheric air through the second inlet 218. In certain aspects, the inlet controller 224 may be movable to various positions between the open configuration and the closed configuration such that atmospheric air may flow into the second inlet 218 at reduced flow rates and/or amounts compared to flow when the inlet controller 224 is in the open configuration. As such, as used herein, the phrase “open configuration” is intended to refer to both a fully open configuration and a partially open configuration.

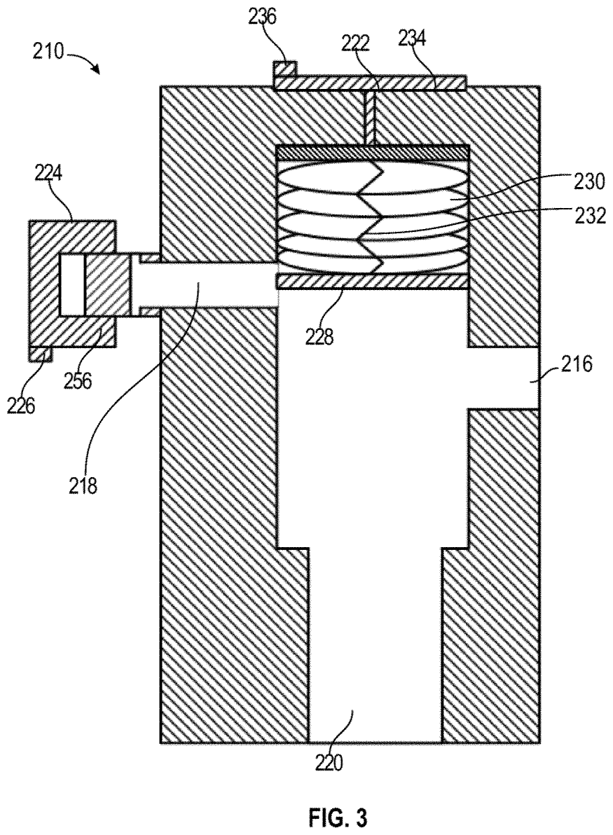

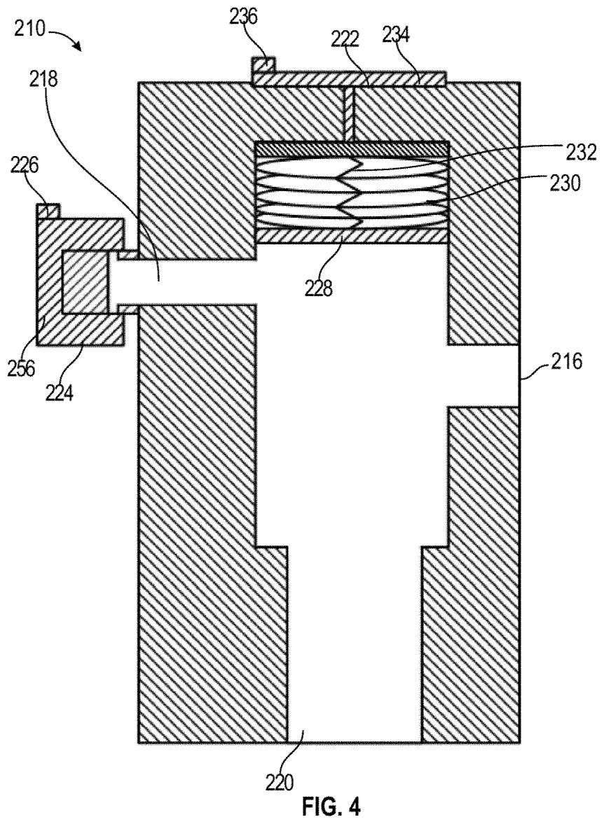

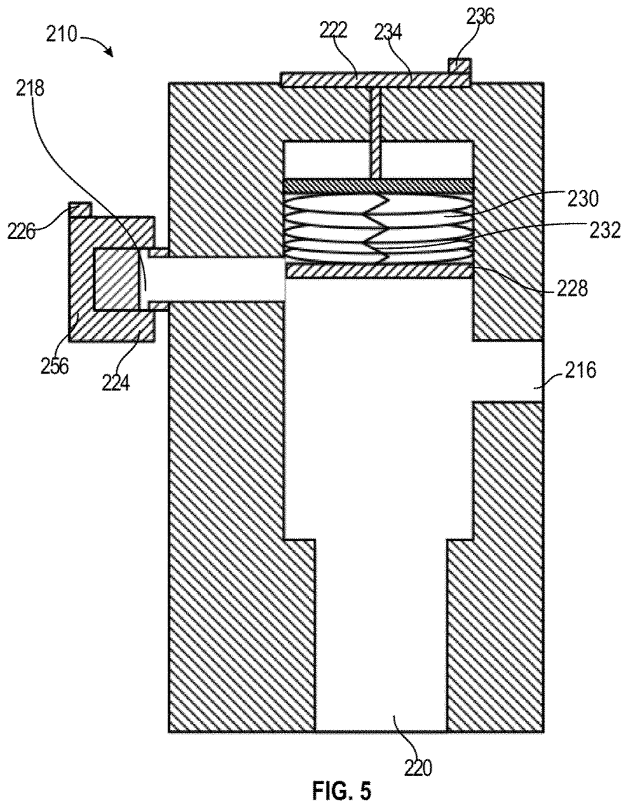

The inlet controller 224 may be various suitable devices or mechanisms as desired suitable for selectively opening or closing the second inlet 218. As some non-limiting examples, the inlet controller 224 may include, but is not limited to, valves, diaphragms, stoppers, covers, and/or other devices or components as desired. In the embodiment of FIG. 2, the inlet controller 224 is a slide valve or cover 256 that is supported on the control device 210. FIGS. 2 and 3 illustrate the inlet controller 224 in the open configuration (e.g., not blocking the second inlet 218), and FIGS. 4 and 5 illustrate the inlet controller 224 in the closed configuration (e.g., blocking the second inlet 218).

Optionally, the inlet controller 224 (and/or the second inlet 218) may include a visual indicator 226 that indicates whether the inlet controller 224 is in the open configuration or the closed configuration. As a non-limiting example, in FIGS. 2 and 3, the visual indicator 226 faces downwards indicating the inlet controller 224 is in the open configuration, and in FIGS. 4 and 5, the visual indicator 226 faces upwards indicating that the inlet controller 224 is in the closed configuration. The visual indicator 226 may be various types of indicators as desired, including, but not limited to, knobs, ribs, grooves, flanges, text, colors, lights, and/or other indicators as desired.

As will be discussed in greater detail below, when used, a flow path of supply gas may be defined at least from the first inlet 216 to the outlet 220, and in certain modes, a flow path may also be defined from the second inlet 218 to the outlet 220. While not illustrated in FIG. 2, the control device 210 may include various devices, mechanisms, or components that may selectively connect the outlet line 114 with the control device 210 such that the outlet line 114 is in fluid communication with the outlet 220.

The pressure regulator 222 is configured to maintain a desired outlet pressure at the outlet 220. In certain embodiments, the pressure regulator 222 includes a diaphragm 228 or other suitable device that is movable within the control device 210. An aneroid 230 may selectively bias the diaphragm 228. In the embodiment of FIGS. 2-5, the aneroid 230 is a bellows-style aneroid that selectively expands or contracts based on the pressure that it is exposed to. However, other types of aneroid 230 may be utilized as desired.

In some embodiments, the pressure regulator 222 may also include a pressure controller 234 that may selectively apply a force (e.g., a spring force from a biasing member 232 and/or a force from other suitable devices or mechanisms) on the diaphragm 228. The pressure controller 234 may be operable in at least a first mode (also referred to herein as a “dilution” mode) and a second mode (also referred to herein as a “positive pressure” mode). FIGS. 2 and 3 illustrate the pressure controller in the first mode, and FIGS. 4 and 5 illustrate the pressure controller 234 in the second mode. In various embodiments, and as discussed in greater detail below, the pressure controller 234 may be in the first mode when the inlet controller 224 is in the open configuration (i.e., atmospheric air may flow into the control device 210) and may be in the first mode or the second mode when the inlet controller 224 is in the closed configuration. In various embodiments, in the first mode, the position of the diaphragm 228 is controlled by the aneroid 230, which may expand or contract depending on the barometric pressure (altitude) that the pressure regulator 222 is subjected to. In the second mode, the pressure controller 234 applies the force on the diaphragm 228 to further position the diaphragm 228 compared to the first mode, which in turn increases the pressure at the outlet 220.

Optionally, the pressure regulator 222 (and/or the pressure controller 234) includes a visual indicator 236 that indicates whether the pressure regulator 222 is in the first mode or the second mode. As a non-limiting example, in FIGS. 2-4, the visual indicator 236 is to the left indicating the pressure regulator 222 is in the first mode, and in FIG. 5, the visual indicator 236 is to the right indicating that the pressure regulator 222 is in the second mode. The visual indicator 236 may be various types of indicators as desired, including, but not limited to, ribs, grooves, flanges, text, colors, lights, and/or other indicators as desired.

The control device 210 may be operable in different modes during use. In some embodiments, the control device 210 may be operable in at least a first base mode, a second base mode, and an emergency mode. The first base mode, the second base mode, and the emergency mode are discussed in greater detail below.

FIGS. 2 and 3 illustrate the control device 210 in the first base mode. As illustrated in FIGS. 2 and 3, in the first base mode, the inlet controller 224 is in the open configuration and the pressure regulator is in the dilution mode. In the first base mode, breathable gas may enter the control device 210 via both the second inlet 218 (atmospheric air) and the first inlet 216 (supply gas), and the atmospheric air and the supply gas mix within the control device 210. Depending on the barometric pressure that the control device 210 is exposed to, the aneroid 230 may expand (FIG. 3) or contract (FIG. 2) to position the diaphragm 228 relative to the second inlet 118, thereby controlling the amount of atmospheric air entering the control device 210 and thus the amount of dilution of the supply gas with the atmospheric air. In certain embodiments, the aneroid 230 may expand with decreasing barometric pressure (e.g., decreasing altitude) and contract with increasing barometric pressure. As a non-limiting example, the control device 210 in FIG. 2 is at a barometric pressure that is decreased compared to FIG. 3, and the aneroid 230 is contracted, thereby allowing for an increased flow or amount of atmospheric air into the control device. The control device 210 in FIG. 3 is at an increased barometric pressure compared to FIG. 2, and the aneroid 230 is expanded, thereby reducing flow or amount of atmospheric air into the control device 210. In certain embodiments, at high enough altitudes, the aneroid 230 may expand such that the flow of atmospheric air is blocked and the breathable gas to the user is only provided via the supply gas, even if the inlet controller 224 is in the open configuration. As one non-limiting example, the aneroid 230 may be adapted to block the flow of atmospheric air at an altitude of at least 35,000 ft., although in other embodiments the aneroid 230 may be adapted to block the flow of atmospheric air at other altitudes.

FIG. 4 illustrates the control device 210 in the second base mode. As illustrated in FIG. 4, in the second base mode, the inlet controller 224 is in the closed configuration and the pressure regulator is in the dilution mode. In the second base mode, breathable gas to the user is only supplied via the supply gas flowing through the first inlet 216 because the inlet controller 224 is blocking the second inlet 218. In various embodiments, the control device 210 may be in the second base mode regardless of the altitude of the control device 210. As a non-limiting example, a user may operate the control device 210 in the second base mode if it is desirable to breath only the supply gas, which may be 100% oxygen in some embodiments.

FIG. 5 illustrates the control device 210 in the emergency mode. As illustrated in FIG. 5, in the emergency mode, the inlet controller 224 is in the closed configuration and the pressure regulator is in the positive pressure mode. In the emergency mode, breathable gas to the user is only supplied via the supply gas flowing through the first inlet 216 because the inlet controller 224 is blocking the second inlet 218. In addition, compared to the first base mode, in the emergency mode, the pressure controller 234 applies the spring force to the diaphragm 228 via the biasing member 232 (or other type of force via other devices or mechanisms) to further position the diaphragm 228, which may increase the pressure at the outlet such that a slight positive pressure may be provided to the user on inhalation.

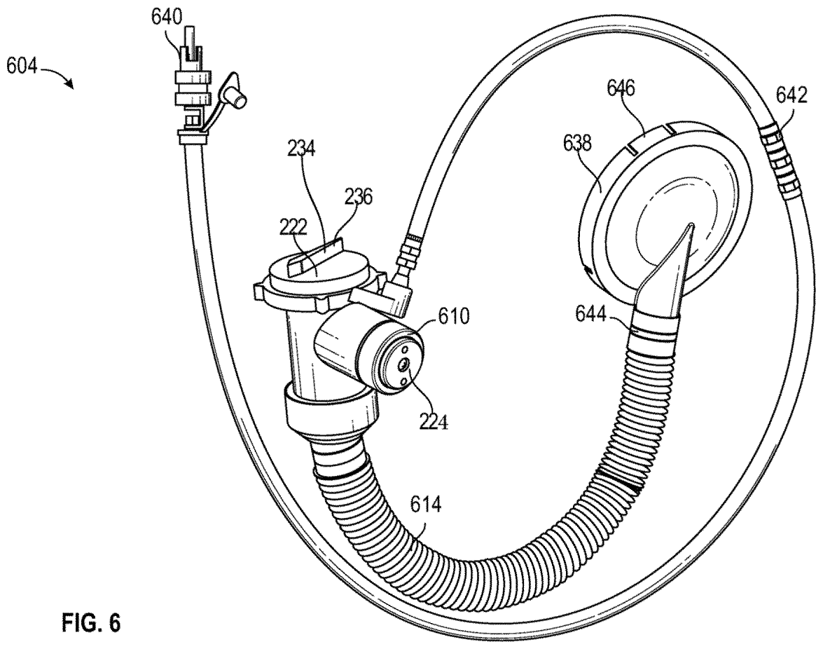

FIGS. 6-9 illustrate another embodiment of an oxygen control system 604 according to various embodiments. The oxygen control system 604 is substantially similar to the oxygen control system 104 and includes a control device 610, a supply line 612, and an outlet line 614. The oxygen control system 604 also includes a filter adaptor 638 that interfaces and forms a seal with a CBRN filter such as the CBRN filter 106.

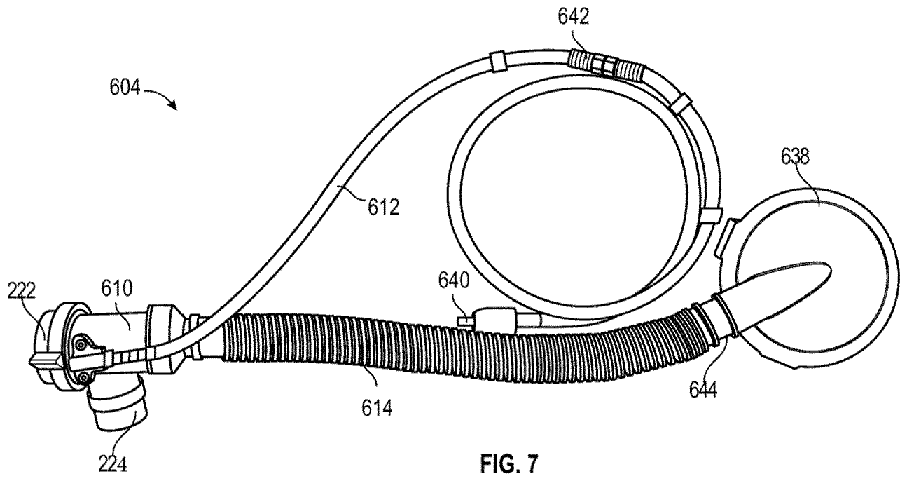

The supply line 612 is substantially similar to the supply line 112 and is adapted to interface with a high pressure gas source. As illustrated in FIGS. 6 and 7, in various embodiments, the supply line 612 includes a connector 640 that is adapted to interface with a high pressure gas source such that the supply gas can be provided to the user via the control device 610. The connector 640 may be various types of connectors as desired and may be connectable to various types of high pressure gas sources. As some non-limiting examples, the connector 640 may be connectable and/or otherwise interface with high pressure gas sources such as compress gas cylinders, compressors, and the like. Optionally, the supply line 612 includes a flow indicator 642 that provides a visual indication of at least one characteristic of the supply gas in the supply line 612. Characteristics of the supply gas may include, but are not limited to, a presence of the supply gas, a flow rate of the supply gas, a pressure of the supply gas, combinations thereof, and/or other suitable characteristics as desired. The supply line 612 is adapted to provide the supply gas at the input pressure. In certain aspects, the supply line 612 may be capable of handling pressures from 50 to 150 PSIG, although in other embodiments the supply line 612 may be capable of handling other pressures as desired.

The control device 610 may be substantially similar to the control device 210 (as well as the control device 110). As illustrated in FIGS. 6 and 7, the supply line 612 is attached to the control device 210 such that the supply line 612 is in fluid communication with the first inlet (not shown) of the control device 610. In some embodiments, the orientation of the supply line 612 relative to the control device 610 is fixed, although in other embodiments the supply line 612 may move relative to the control device 610 and while connected to the control device 610. Optionally, a seal (not shown) may be provided between the control device 610 and the supply line 612.

The control device 610 may optionally include various attachment features such that the control device 610 can be attached to a user and/or devices associated with the user when used. Attachment features may include, but are not limited to, straps, snaps, hook and loop fasteners, and/or other suitable devices or mechanisms as desired. In certain embodiments, the attachment features may allow for the control device 610 to be supported at various locations on a user and/or devices associated with the user, including, but not limited to, a utility vest, body armor, a restraint harness, or a portable oxygen cylinder.

The outlet line 614 may be substantially similar to the outlet line 114. As illustrated in FIGS. 6 and 7, the outlet line 614 is connected to the control device 610 such that the outlet line 614 is in fluid communication with the outlet (not shown) of the control device 610. In certain embodiments, the outlet line 614 is adapted to supply the breathable gas from the control device 610 at an outlet pressure that is less than the input pressure. The breathable gas from the control device 610 may be just the supply gas at a reduced pressure or may be a mixture of the supply gas with atmospheric air based on the mode of the control device 610.

Similar to the supply line 612, the orientation of the outlet line 614 relative to the control device 610 may be fixed or adjustable as desired. In some embodiments, the outlet line 614 is threadably connected to the control device 610, although in other embodiments the outlet line 614 may be attached to the control device 610 via various other devices or mechanisms as desired. Optionally, a seal (not shown) may be provided between the control device 610 and the outlet line 614. The outlet line 614 may have various shapes or profiles as desired. In one non-limiting embodiment, the portion of the outlet line 614 connected to the control device 610 may have sloping sides.

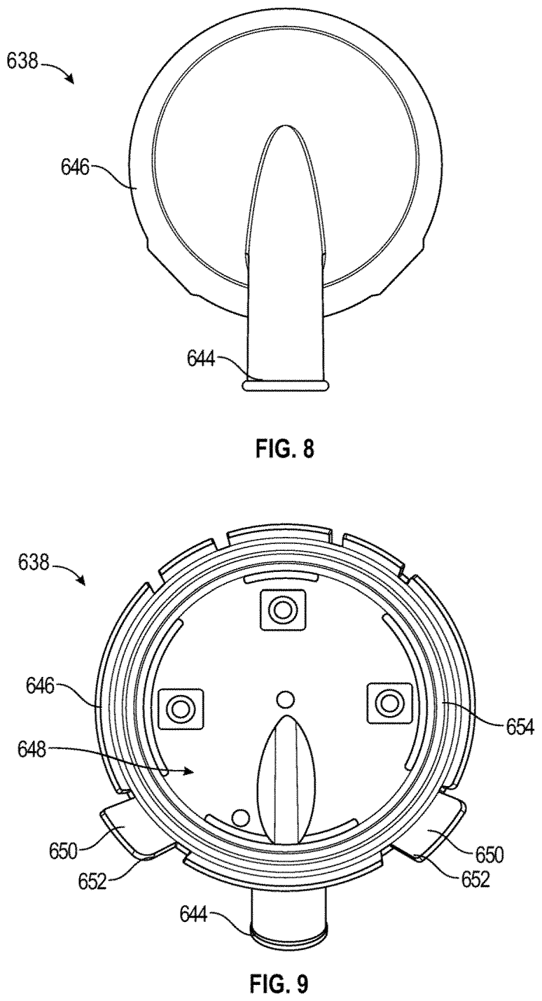

In some embodiments, the oxygen control system 604 also includes the filter adaptor 638 that is adapted to interface and form a seal with a CBRN filter. As best illustrated in FIGS. 8 and 9, the filter adaptor 638 includes an inlet portion 644 and an outlet portion 646. The inlet portion 644 connects the filter adaptor 638 with the outlet line 614, and the outlet portion 646 includes a cavity 648 that is adapted to accommodate the body of each CBRN filter. In certain embodiments, the outlet portion 646 includes one or more retention mechanisms 650 that selectively hold the filter adaptor 638 on the CBRN filter. In the embodiment of FIGS. 6-9, the retention mechanisms 650 include two flexible tabs or tabs 652, although other types of retentions mechanisms may be utilized as desired. In some embodiments, the outlet portion 646 includes a sealing rim 654 that contacts and forms a seal with the body of the CBRN filter when the filter adaptor 638 is attached to the CBRN filter.

A collection of exemplary embodiments are provided below, including at least some explicitly enumerated as “Examples” providing additional description of a variety of example embodiments in accordance with the concepts described herein. These examples are not meant to be mutually exclusive, exhaustive, or restrictive; and the disclosure not limited to these examples but rather encompasses all possible modifications and variations within the scope of the issued claims and their equivalents.

Example 1. An oxygen control system for an oxygen mask, the system comprising: a supply line configured to provide a flow of a supply gas at an input pressure; a control device comprising: a first inlet in fluid communication with the supply line, wherein the first inlet enables the flow of the supply gas at an input pressure into the control device; a second inlet enables a flow of atmospheric air into the control device; an outlet in fluid communication with the first inlet and the second inlet; and a pressure regulator, wherein the pressure regulator is operable in a first mode and a second mode, wherein, in the first mode, the pressure regulator reduces input pressure of the gas to a first outlet pressure at the outlet, and wherein, in the second mode, the pressure regulator reduces the input pressure of the gas to a second outlet pressure at the outlet that is greater than the first outlet pressure; and an outlet line connected to the outlet of the control device and configured to supply the supply gas at the first outlet pressure or the second outlet pressure, wherein the first outlet pressure and the second outlet pressure are less than the input pressure.

Example 2. The system of any of the preceding or subsequent examples or combination of examples, wherein the control device further comprises an inlet controller configured to control the flow of atmospheric air through the second inlet and into the control device, wherein the inlet controller is movable between an open position and a closed position.

Example 3. The system of any of the preceding or subsequent examples or combination of examples, wherein the control device is operable in a first base mode, a second base mode, and an emergency mode, wherein: in the first base mode, the pressure regulator is in the first mode and the inlet controller is in the open position; in the second base mode, the pressure regulator is in the first mode and the inlet controller is in the closed position; and in the emergency mode, the pressure regulator is in the second mode and the second inlet is in the closed position.

Example 4. The system of any of the preceding or subsequent examples or combination of examples, wherein the supply line further comprises a supply line connector, wherein the supply line connector is configured to interface with the high pressure gas source.

Example 5. The system of any of the preceding or subsequent examples or combination of examples, wherein the supply line further comprises a visual flow indicator.

Example 6. The system of any of the preceding or subsequent examples or combination of examples, wherein the supply gas from the supply line comprises 100% oxygen.

Example 7. The system of any of the preceding or subsequent examples or combination of examples, further comprising a filter adaptor connected to the outlet line opposite from the control device, wherein the filter adaptor is configured to cover a filter body of a CBRN filter.

Example 8. The system of any of the preceding or subsequent examples or combination of examples, wherein the filter adaptor comprises an adaptor inlet and an adaptor outlet, wherein the adaptor inlet is connected to the outlet line, and wherein the adaptor outlet comprises at least two tangs configured to selectively retain the filter on the filter adaptor.

Example 9. The system of any of the preceding or subsequent examples or combination of examples, wherein the filter adaptor is connectable to an oxygen mask.

Example 10. An oxygen control system for an oxygen mask, the system comprising a control device, the control device comprising: a first inlet enabling a flow of a supply gas from a high pressure gas source; a second inlet enabling a flow of atmospheric air into the control device; an inlet controller configured to control the flow of atmospheric air through the second inlet and into the control device, wherein the inlet controller is movable between an open position and a closed position; an outlet in fluid communication with the first inlet and the second inlet; and a pressure regulator, wherein the pressure regulator is operable in a first mode and a second mode, wherein, in the first mode, the pressure regulator reduces input pressure of the gas to a first outlet pressure at the outlet, and wherein, in the second mode, the pressure regulator reduces the input pressure of the gas to a second outlet pressure at the outlet that is greater than the first outlet pressure, wherein the control device is operable in a first base mode, a second base mode, and an emergency mode, wherein: in the first base mode, the pressure regulator is in the first mode and the inlet controller is in the open position; in the second base mode, the pressure regulator is in the first mode and the inlet controller is in the closed position; and in the emergency mode, the pressure regulator is in the second mode and the inlet controller is in the closed position.

Example 11. The system of any of the preceding or subsequent examples or combination of examples, further comprising a supply line connected to the first inlet and configured to provide the supply gas at an input pressure, wherein the input pressure is greater than the first outlet pressure and the second outlet pressure.

Example 12. The system of any of the preceding or subsequent examples or combination of examples, further comprising: an outlet line connected to the outlet; and a filter adaptor connected to the outlet line, wherein the filter adaptor is configured to cover a filter body of a CBRN filter.

Example 13. The system of any of the preceding or subsequent examples or combination of examples, wherein the inlet controller comprises a cover rotatably supported on the control device.

Example 14. The system of any of the preceding or subsequent examples or combination of examples, wherein the pressure regulator comprises a bellows style aneroid.

Example 15. The system of any of the preceding or subsequent examples or combination of examples, wherein the inlet controller comprises a first visual indicator, and wherein the pressure regulator comprises a second visual indicator.

Example 16. An oxygen control system for an oxygen mask, the system comprising: a control device comprising: a first inlet enabling a flow of supply gas into the control device at an input pressure; a second inlet enabling a flow of atmospheric air into the control device; an inlet controller configured to control the flow of atmospheric air through the second inlet and into the control device, wherein the inlet controller is movable between an open position and a closed position; and a pressure regulator, wherein the pressure regulator is operable in a first mode and a second mode, wherein, in the first mode, the pressure regulator reduces input pressure of the gas to a first outlet pressure at the outlet, and wherein, in the second mode, the pressure regulator reduces the input pressure of the gas to a second outlet pressure at the outlet that is greater than the first outlet pressure; an outlet line connected to the outlet of the control device; and a filter adaptor connected to the outlet line, wherein the filter adaptor is configured to cover a filter body of a CBRN filter.

Example 17. The system of any of the preceding or subsequent examples or combination of examples, further comprising a supply line connectable to the high pressure gas source and configured to supply the supply gas from the high pressure gas source, wherein the supply line is connected to the first inlet.

Example 18. The system of any of the preceding or subsequent examples or combination of examples, wherein the input pressure in the supply line is greater than the first outlet pressure and the second outlet pressure.

Example 19. The system of any of the preceding or subsequent examples or combination of examples, wherein the control device is operable in a first base mode, a second base mode, and an emergency mode, wherein: in the first base mode, the pressure regulator is in the first mode and the inlet controller is in the open position; in the second base mode, the pressure regulator is in the first mode and the inlet controller is in the closed position; and in the emergency mode, the pressure regulator is in the second mode and the inlet controller is in the closed position.

Example 20. The system of any of the preceding or subsequent examples or combination of examples, wherein the filter adaptor comprises an adaptor inlet and an adaptor outlet, wherein the adaptor inlet is connected to the outlet line, and wherein the adaptor outlet comprises at least two tangs configured to selectively retain the filter on the filter adaptor.

Different arrangements of the components depicted in the drawings or described above, as well as components and steps not shown or described, are possible. Similarly, some features and sub-combinations are useful and may be employed without reference to other features and sub-combinations. Embodiments of the invention have been described for illustrative and not restrictive purposes, and alternative embodiments may become apparent to readers of this patent. Accordingly, the present invention is not limited to the embodiments described above or depicted in the drawings, and various embodiments and modifications may be made without departing from the scope of the claims below.

That which is claimed is:

1. An oxygen control system for an oxygen mask, the system comprising:
a supply line configured to provide a flow of a supply gas at an input pressure;
a control device comprising:
a first inlet in fluid communication with the supply line, wherein the first inlet enables the flow of the supply gas at an input pressure into the control device;
a second inlet enables a flow of atmospheric air into the control device;
an outlet in fluid communication with the first inlet and the second inlet; and
a pressure regulator, wherein the pressure regulator is operable in a first mode and a second mode, wherein, in the first mode, the pressure regulator reduces input pressure of the gas to a first outlet pressure at the outlet, and wherein, in the second mode, the pressure regulator reduces the input pressure of the gas to a second outlet pressure at the outlet that is greater than the first outlet pressure; and
an outlet line connected to the outlet of the control device and configured to supply the supply gas at the first outlet pressure or the second outlet pressure, wherein the first outlet pressure and the second outlet pressure are less than the input pressure.

2. The system of claim 1, wherein the control device further comprises an inlet controller configured to control the flow of atmospheric air through the second inlet and into the control device, wherein the inlet controller is movable between an open position and a closed position.

3. The system of claim 2, wherein the control device is operable in a first base mode, a second base mode, and an emergency mode,
wherein:
in the first base mode, the pressure regulator is in the first mode and the inlet controller is in the open position;
in the second base mode, the pressure regulator is in the first mode and the inlet controller is in the closed position; and
in the emergency mode, the pressure regulator is in the second mode and the second inlet is in the closed position.

4. The system of claim 1, wherein the supply line further comprises a supply line connector, wherein the supply line connector is configured to interface with a high pressure gas source.

5. The system of claim 1, wherein the supply line further comprises a visual flow indicator.

6. The system of claim 1, wherein the supply gas from the supply line comprises 100% oxygen.

7. The system of claim 1, further comprising a filter adaptor connected to the outlet line opposite from the control device, wherein the filter adaptor is configured to cover a filter body of a chemical, biological, radiological, or nuclear (CBRN) filter.

8. The system of claim 7, wherein the filter adaptor comprises an adaptor inlet and an adaptor outlet, wherein the adaptor inlet is connected to the outlet line, and wherein the adaptor outlet comprises at least two tangs configured to selectively retain the filter on the filter adaptor.

9. The system of claim 7, wherein the filter adaptor is connectable to an oxygen mask.

10. An oxygen control system for an oxygen mask, the system comprising a control device, the control device comprising:
a first inlet enabling a flow of a supply gas from a high pressure gas source;
a second inlet enabling a flow of atmospheric air into the control device;
an inlet controller configured to control the flow of atmospheric air through the second inlet and into the control device, wherein the inlet controller is movable between an open position and a closed position;
an outlet in fluid communication with the first inlet and the second inlet; and
a pressure regulator, wherein the pressure regulator is operable in a first mode and a second mode, wherein, in the first mode, the pressure regulator reduces input pressure of the gas to a first outlet pressure at the outlet, and wherein, in the second mode, the pressure regulator reduces the input pressure of the gas to a second outlet pressure at the outlet that is greater than the first outlet pressure,
wherein the control device is operable in a first base mode, a second base mode, and an emergency mode,
wherein:
in the first base mode, the pressure regulator is in the first mode and the inlet controller is in the open position;
in the second base mode, the pressure regulator is in the first mode and the inlet controller is in the closed position; and
in the emergency mode, the pressure regulator is in the second mode and the inlet controller is in the closed position.

11. The system of claim 10, further comprising a supply line connected to the first inlet and configured to provide the supply gas at an input pressure, wherein the input pressure is greater than the first outlet pressure and the second outlet pressure.

12. The system of claim 10, further comprising:
an outlet line connected to the outlet; and
a filter adaptor connected to the outlet line, wherein the filter adaptor is configured to cover a filter body of a chemical, biological, radiological, or nuclear (CBRN) filter.

13. The system of claim 10, wherein the inlet controller comprises a cover rotatably supported on the control device.

14. The system of claim 10, wherein the pressure regulator comprises a bellows style aneroid.

15. The system of claim 10, wherein the inlet controller comprises a first visual indicator, and wherein the pressure regulator comprises a second visual indicator.

16. An oxygen control system for an oxygen mask, the system comprising:
a control device comprising:
a first inlet enabling a flow of supply gas into the control device at an input pressure;
a second inlet enabling a flow of atmospheric air into the control device;
an inlet controller configured to control the flow of atmospheric air through the second inlet and into the control device, wherein the inlet controller is movable between an open position and a closed position; and
a pressure regulator, wherein the pressure regulator is operable in a first mode and a second mode, wherein, in the first mode, the pressure regulator reduces input pressure of the gas to a first outlet pressure at the outlet, and wherein, in the second mode, the pressure regulator reduces the input pressure of the gas to a second outlet pressure at the outlet that is greater than the first outlet pressure;
an outlet line connected to the outlet of the control device; and
a filter adaptor connected to the outlet line, wherein the filter adaptor is configured to cover a filter body of a chemical, biological, radiological, or nuclear (CBRN) filter.

17. The system of claim 16, further comprising a supply line connectable to a high pressure gas source and configured to supply the supply gas from the high pressure gas source, wherein the supply line is connected to the first inlet.

18. The system of claim 17, wherein the input pressure in the supply line is greater than the first outlet pressure and the second outlet pressure.

19. The system of claim 16, wherein the control device is operable in a first base mode, a second base mode, and an emergency mode,
wherein:
in the first base mode, the pressure regulator is in the first mode and the inlet controller is in the open position;
in the second base mode, the pressure regulator is in the first mode and the inlet controller is in the closed position; and
in the emergency mode, the pressure regulator is in the second mode and the inlet controller is in the closed position.

20. The system of claim 16, wherein the filter adaptor comprises an adaptor inlet and an adaptor outlet, wherein the adaptor inlet is connected to the outlet line, and wherein the adaptor outlet comprises at least two tangs configured to selectively retain the filter on the filter adaptor.
